(19) United States
(12) Patent Application Publication
(10) Pub. No.: US 2026/0338988 A1
(43) Pub. Date: Oct. 29, 2026

(54) METHOD AND ELECTRONIC APPARATUS FOR IMPLICIT GEOLOGICAL MODELING BASED ON ADAPTIVE GRIDS

(71) Applicant: China Aero Geophysical Survey and Remote Sensing Center for Natural Resources, Beijing (CN)

(72) Inventors: Zhaoliang LI, Beijing (CN); Baodi WANG, Beijing (CN); Shengqing XIONG, Beijing (CN); Xingsu LI, Beijing (CN); Zhangang WANG, Beijing (CN); Guoxi SONG, Beijing (CN)

(73) Assignee: China Aero Geophysical Survey and Remote Sensing Center for Natural Resources, Beijing (CN)

(21) Appl. No.: 19/393,066

(22) Filed: Nov. 18, 2025

(30) Foreign Application Priority Data
Apr. 29, 2025 (CN) 202510553954.3

(51) Int. Cl. G01V 20/00

(52) U.S. Cl. CPC G01V 20/00

(57) ABSTRACT

The present disclosure discloses a method and an electronic apparatus for implicit geological modeling based on adaptive grids. One embodiment of the method includes: performing initial grid division on a computational region according to geological modeling parameters and geological source data to obtain a first grid set; determining grids to be refined in the first grid set according to a preset determination rule; dividing the grids to be refined into sub-element sets according to a preset refinement rule to obtain a second grid set of the computational region; storing grid data of the second grid set; performing differentiation on the second grids in the second grid set and determining a coefficient matrix A based on differentiation coefficients; constructing a linear equation set Ax=b based on the Lagrange multiplier method, where vector b is used to represent point constraints and directional constraint conditions; solving the linear equation set to obtain second grid values, and outputting modeling results based on the second grid values. Therefore, a new implicit geological modeling based on adaptive grids is proposed.

### CROSS-REFERENCE TO RELATED APPLICATION

This application claims priority to Chinese Patent Application No. CN202510553954.3, filed on Apr. 29, 2025, which is hereby incorporated by reference in its entirety.

### TECHNICAL FIELD

The present disclosure relates to the field of computer technology, specifically to a method and an electronic apparatus for implicit geological modeling based on adaptive grids.

### BACKGROUND

With the continuous development of computer technology and the popularization of high-performance computing resources, computer-based geological modeling plays an important role increasingly in fields such as resource exploration, environmental protection, and disaster prediction. Geological modeling is a process of describing, interpreting, and predicting geological entities, and is a vital part of the fields such as geology, resource exploration, and environmental science. The geological modeling is mainly used to construct underground structure and attribute models based on geological data (e.g., borehole data, geophysical data, geological images, etc.), to help understand geological processes, guide resource exploration and management, and assess geological disaster risks.

Geological modeling methods in the art mainly involve manual modeling and model fitting based on rules. Such methods face challenges such as low computation speed, strong subjectivity, and reliance on professional expertise when processing large-scale geological data, so that it is difficult to meet the needs of modern geological engineering.

### BRIEF SUMMARY

The present disclosure is provided to make a brief introduction of the concepts, which will be described in detail in the embodiments hereafter. This part of Summary is not intended to identify key features or essential characteristics of the claimed technical solutions, nor is it intended to limit the scope of the claimed technical solutions.

In one aspect, an embodiment of the present disclosure provides a method for implicit geological modeling based on adaptive grids including: performing initial grid division on a computational region according to geological modeling parameters and geological source data to obtain a first grid set; determining grids to be refined in the first grid set according to a preset determination rule; dividing the grids to be refined into sub-element sets according to a preset refinement rule to obtain a second grid set of the computational region; storing grid data of the second grid set; performing differentiation on the second grids in the second grid set and determining a coefficient matrix A based on differentiation coefficients; constructing a linear equation set Ax=b based on the Lagrange multiplier method, where vector b is used to represent point constraints and directional constraint conditions; solving the linear equation set to obtain second grid values, and outputting modeling results based on the second grid values.

Alternatively, the determining grids to be refined in the first grid set according to a preset determination rule includes: marking grids based on refinement levels, where grids containing control points or fault points are marked as level 2, grids directly adjacent to grids containing control points or fault points are marked as level 1, and other grids are marked as level 0; and determining grids marked as level 2 or 1 as the grids to be refined.

Alternatively, the dividing the grids to be refined into sub-element sets according to a preset refinement rule to obtain a second grid set of the computational region includes: performing refinement on the grid region where the grid to be refined is located with a 3*3 grid region centered on the grid to be refined as the basic processing unit; checking a refinement level of the grid where the grid to be refined is located after one refinement process is completed; continuing refinement recursively, if the refinement level of the grid where the grid to be refined is located is less than a specified refinement level; stopping a recursive process, if the refinement level of the grid to be refined is less than the specified refinement level by one, and performing one more refinement on grids currently marked as level 2, so that the grid to be refined reaches the specified refinement level, and the refinement level difference between grids adjacent to the grid to be refined and the grid to be refined is 1.

Alternatively, the performing refinement on the grid region where the grid to be refined is located includes: adding four edge nodes and one center node to the grid in the grid region, and forming four refined grid elements with the nodes newly added and original grid nodes.

Alternatively, the storing grid data of the second grid set includes: storing grids of each level separately according to respective refinement levels; wherein each layer of grids in single-layer grid structure of each level in the first storage space are regarded as uniform grids corresponding to a resolution of respective refinement level; marks of grid points in the single-layer grid are stored in a second storage space, where index values of grid points that actually exist in the second grid set are stored, and grid points that do not exist are marked as −1.

Alternatively, the performing differentiation on the second grids in the second grid set includes: determining whether to add points to the second grids; performing interpolating based on existing grid points to obtain missed grid points in response to a determination for adding points to the second grids, and performing differentiation with the added points.

Alternatively, the determining whether to add points to the second grids includes: determining whether grid points of the same level in neighborhood of point T to be differentiated are missing for the point T to be differentiated; making determination for adding points for the missing grid points, if grid points of the same level in neighborhood of point T to be differentiated are missing.

Alternatively, the performing interpolating based on existing grid points to obtain missed grid points in response to a determination for adding points to the second grids includes: adding points for the missing grid point based on two endpoints of the grid line, if the missing grid point is located on the grid line; adding points for the missing grid point based on points on the grid lines of the grid where a grid center is located, if the missing grid point is located at the grid center.

Alternatively, the performing interpolating based on existing grid points to obtain missed grid points in response to a determination for adding points to the second grids includes: adding points for the missing points on the grid lines of a three-dimensional grids based on existing points on the grid lines to obtain points on lines of the three-dimensional grids, if the missing grid point is located at a centroid of a three-dimensional grids; and adding points for the missing points located at the centroid of the three-dimensional grids based on the points on lines of the three-dimensional grids.

In another aspect, an embodiment of the present disclosure provides an electronic apparatus, including: one or more processors; and a storage device configured to store one or more programs, wherein the one or more programs, when executed by the one or more processors, cause the one or more processors to implement the method according to any of the embodiments in the first aspect.

### BRIEF DESCRIPTION OF THE DRAWINGS

The present disclosure and other features, advantages, and aspects of the embodiments of the present disclosure will become more apparent in conjunction with the accompanying drawings and the following detailed description of specific embodiments. Throughout the drawings, identical or similar reference numerals represent identical or similar elements. It should be understood that the drawings are illustrative, and the original components and elements may not necessarily be drawn to scale.

FIG. 1 is a flowchart of an embodiment of the method for implicit geological modeling based on adaptive grids according to the present disclosure.

FIG. 2 is a diagram illustrating an adaptive refinement process for grids.

FIG. 3 is a flowchart of the recursive adaptive refinement algorithm.

FIG. 4 is a diagram of the adaptive grid data structure.

FIG. 5 is a diagram schematically showing a method for adding points and differentiation for two-dimensional adaptive grids.

FIG. 6 is a diagram schematically showing a method for adding points and differentiation for three-dimensional adaptive grids.

FIG. 7 is a diagram schematically showing a basic structure of the electronic apparatus provided by the embodiment of the present disclosure.

### DETAILED DESCRIPTION

The embodiments of the present disclosure will be described in detail below with reference to the drawings. While specific embodiments of the present disclosure are shown in the drawings, it should be understood that the present disclosure may be implemented in various forms and should not be construed as being limited to the embodiments described herein. Instead, these embodiments are provided to facilitate a more thorough and comprehensive understanding of the present disclosure. It should be understood that the drawings and embodiments of the present disclosure are illustrative and are not intended to limit the scope of the present disclosure.

It should be understood that the steps described in the embodiments for method in the present disclosure can be performed in a different order and/or in parallel. Furthermore, the embodiments for the method may include additional steps and/or omit the illustrated steps. The scope of the present disclosure is not limited in this regard.

The term “comprising” and its variations used herein are open-ended terms meaning “including but not limited to.” The term “based on” means “at least partially based on.” The term “an embodiment” means “at least one embodiment,” and the term “another embodiment” means “at least one other embodiment.” The term “some embodiments” means “at least some embodiments.” Relevant definitions of other terms will be provided in the description below.

It should be noted that the concepts of “first,” “second,” and so forth mentioned in the present disclosure are only used to distinguish different devices, modules, or units and are not intended to define the order or interdependence of the functions performed by these devices, modules, or units.

It should also be noted that the modifiers “a,” “an,” and “multiple” mentioned in the present disclosure are illustrative and not restrictive. Those skilled in the art should understand that unless explicitly stated otherwise, “a” or “multiple” should be understood as “one or more.”

The names of messages or information exchanged between multiple devices in the embodiments of the present disclosure are only for illustrative purposes and are not intended to limit the scope of these messages or information.

Implicit geological modeling, as a data-driven geological modeling method, may infers structures and attributes underground automatically by utilizing spatial relationships and physical characteristics in geological data to generate geological models. Compared with methods in the prior art, implicit geological modeling has the advantages of high automation, fast modeling speed, and suitability for complex geological environments. Implicit geological modeling may transform the geological modeling problem into an optimization problem, to optimize model parameters to best fit the geological data by minimizing the residuals between geological data and the model, so that geological modeling may be achieved. However, the computational complexity of implicit geological modeling is high. Methods in the prior art often fail to meet the requirements for accuracy, real-time performance, and efficiency, especially when processing large-scale geological data.

One or more embodiments of the present disclosure provide a method for implicit geological modeling based on adaptive grids to address the issues of long computation time, low model accuracy, difficulty in handling complex constrained construction areas, and low modeling efficiency in implicit geological modeling methods in the prior art, and to achieve efficient modeling of large-scale geological datasets.

One or more embodiments of the present disclosure introduce an adaptive grid system, so as to fully leverage advantages of multi-resolution adaptive grids, and significantly reduce the number of grid points and the size of the coefficient matrix.

In one or more embodiments of the present disclosure, in view of the characteristics of large-scale and highly complex rendering in implicit geological modeling data, the overall accuracy and reliability of the model may be improved effectively by utilizing multi-scale modeling means based on adaptive grids and adjusting modeling parameters and resolution dynamically according to features of geological data and specific modeling requirements.

In one or more embodiments of the present disclosure, an adaptive grid system may be introduced to refine grid cells containing geological data while maintaining coarse grids in other areas, so as to avoid extensive unnecessary computations in non-critical regions for modeling, so that the accuracy and efficiency of the implicit geological modeling method may be improved greatly.

In one or more embodiments of the present disclosure, a refinement process by the adaptive grid method is a highly intelligent process, which may conduct adjustment dynamically based on specific criteria. Each grid cell in the grid may be considered as a refinable element, and each element has its own refinement level, representing the number of refining processing the element to be undergone in the refinement process for adaptive grids. In initialization, the entire computational region may be divided into grids initially, which are typically relatively coarse and cover the entire region to be solved. Each grid element has an initial number for refining processing. As adaptive refining progresses, when an element needs to be refined, its refinement level increases. Each refinement operation essentially divides the grid element into smaller sub-element sets according to a predetermined rule. During refinement, new grid nodes are first generated for the grid element, and new grid cells are formed by connecting the grid nodes.

In one or more embodiments of the present disclosure, a data structure for adaptive grids is proposed. A layered data structure designed for the adaptive grid system is developed based on the characteristics of adaptive grids with various refinement levels. This structure effectively stores grid information in regions of varying density and enables fast and efficient data access.

In one or more embodiments of the present disclosure, an improved finite difference discretization method is proposed for adaptive grids with uneven refinement level distribution among grids.

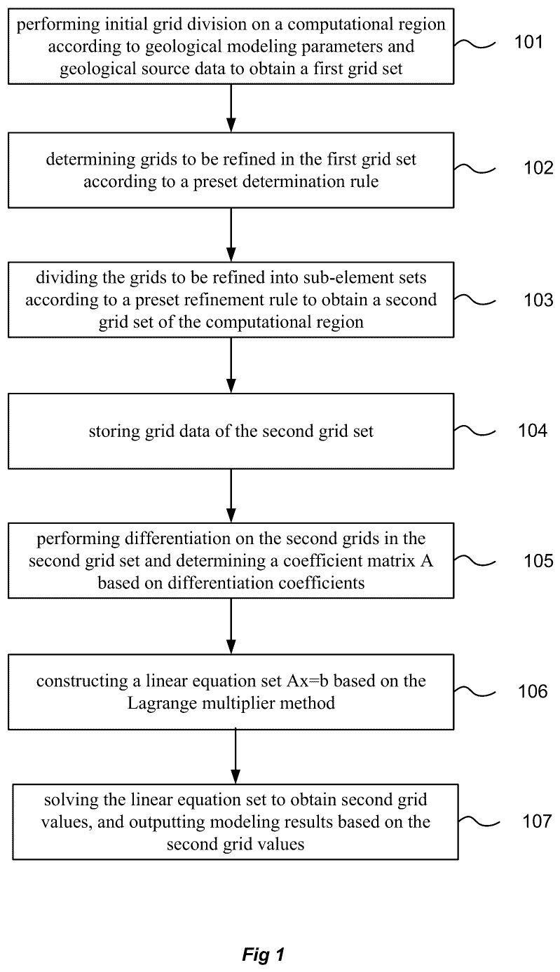

With reference to FIG. 1, which showing a flowchart of an embodiment of the method for implicit geological modeling based on adaptive grids according to the present disclosure. As shown in FIG. 1, the method for implicit geological modeling based on adaptive grids includes the following steps:
Step 101: performing initial grid division on a computational region according to geological modeling parameters and geological source data to obtain a first grid set.
Step 102: determining grids to be refined in the first grid set according to a preset determination rule.
Step 103: dividing the grids to be refined into sub-element sets according to a preset refinement rule to obtain a second grid set of the computational region.
Step 104: storing grid data of the second grid set.
Step 105: performing differentiation on the second grids in the second grid set and determining a coefficient matrix A based on differentiation coefficients.
Step 106: constructing a linear equation set Ax=b based on the Lagrange multiplier method.

In the present embodiment, vector b is configured to represent point constraints and directional constraint conditions.
Step 107: solving the linear equation set to obtain second grid values, and outputting modeling results based on the second grid values.

Geological modeling parameters or geological source data can be set according to specific scenario for geological modeling and there is no limitation thereon herein.

The preset refinement rule is used to determine whether to refine the first grid. For example, the grid where a control point or a fault point is located may be determined as a grid to be refined. For example, a grid adjacent to a grid where a control point or a fault point is located may be determined as grids to be refined.

The preset refinement rule is configured to provide specific methods for refinement and can be set according to actual application scenarios.

In finite difference and finite element methods, grid is basis for discretizing the computational region.

The first grid set may be a grid set obtained by initial coarse division on the computational region.

The second grid set may be a grid set obtained after one or more refining processing on the first grid.

Stored grid data may be read to be used during differentiation.

Lagrange multiplier method may be used in constructing a linear equation set Ax=b based on the Lagrange multiplier method.

The operation of solving the linear equation set to obtain second grid values may be determined by using mathematical algorithms for solving linear equations. Regarding the processing of outputting modeling results based on second grid values, it can be understood that the second grid values are kind of modeling result to some level. Those skilled in the art may read or present the second grid values based on actual scenarios, and the output serves as modeling results.

It should be noted that the method for implicit geological modeling based on adaptive grids provided in the present embodiment may refine grids to capture subtle variations in geological attributes around control points more accurately and ensure that the model closely matches the actual geological conditions in these areas, so that a solid foundation for the accuracy may be established for the entire model. In other areas outside the control points, coarse grids are maintained to not only avoid excessive computational resource investment in regions where there are minimal impact on the overall model accuracy but also prevent inefficiency caused by unnecessary high-precision calculations, and further to ensure the overall quality of the model with data storage and computation time significantly reduced, so that the implicit geological modeling method may remain efficient and stable when dealing with large-scale complex geological scenarios, and an optimal balance between accuracy and efficiency may be achieved.

In comparison, traditional uniform grids adopt fixed grid spacing throughout the computational region. This means the same grid resolution is maintained in areas with nearly zero gradient in the solution, as well as in key regions where physical phenomena change drastically and require extremely high accuracy.

In some embodiments, the determining grids to be refined in the first grid set according to a preset determination rule includes: marking grids based on refinement levels, where grids containing control points or fault points are marked as level 2, grids directly adjacent to grids containing control points or fault points are marked as level 1, and other grids are marked as level 0; and determining grids marked as level 2 or 1 as the grids to be refined.

In some embodiments, the dividing the grids to be refined into sub-element sets according to a preset refinement rule to obtain a second grid set of the computational region includes: performing refinement on the grid region where the grid to be refined is located with a 3*3 grid region centered on the grid to be refined as the basic processing unit; checking a refinement level of the grid where the grid to be refined is located after one refinement process is completed; continuing refinement recursively, if the refinement level of the grid where the grid to be refined is located is less than a specified refinement level; stopping a recursive process, if the refinement level of the grid to be refined is less than the specified refinement level by one, and performing one more refinement on grids currently marked as level 2, so that the grid to be refined reaches the specified refinement level, and the refinement level difference between grids adjacent to the grid to be refined and the grid to be refined is 1.

In some embodiments, the performing refinement on the grid region where the grid to be refined is located includes: adding four edge nodes and one center node to the grid in the grid region, and forming four refined grid elements with the nodes newly added and original grid nodes.

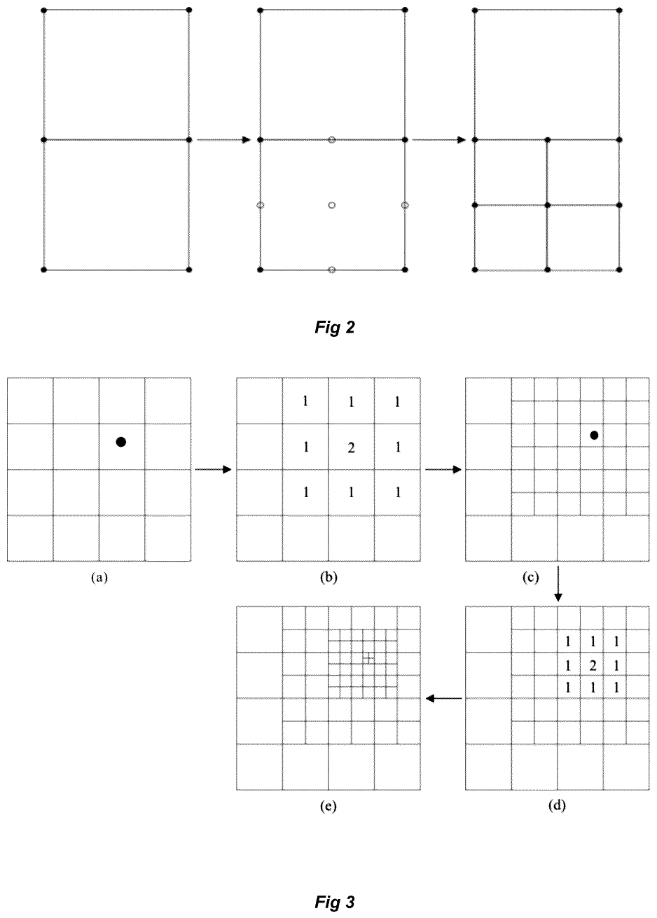

As an example, as shown in FIG. 2, four edge nodes and one center node are added to the grid, and the nodes newly added are connected with the original grid nodes to form four grid elements with higher refinement level, so that grid subdivision may be achieved. Similarly, the refinement strategy for two-dimensional quadrilateral grids can be extended to three-dimensional regular grids, where grid elements become eight-node hexahedrons from four-node quadrilaterals.

In one or more embodiments of the present disclosure, a method for fixing the hierarchical difference of grids is proposed. Hierarchical difference refers to the difference in refinement levels between adjacent grid elements, which may show a spatial non-uniformity in refining grids. The fixed hierarchical difference of grids may ensure a consistency of discrete formats. In numerical methods, the consistency of discrete formats (e.g., finite difference, finite element, etc.) is crucial for obtaining accurate solutions. In the adaptive grid method adopted in the present disclosure, the maximum hierarchical difference between adjacent grids is 1, so that consistent differentiation formats may be obtained and the numerical accuracy of the grid system may be achieved.

In one or more embodiments of the present disclosure, a recursive adaptive refinement algorithm is proposed to maintain a unified hierarchical difference while achieving grid refinement efficiently. The recursive adaptive refinement algorithm uses 3*3 grid region centered on a grid containing control point or a fault point as a basic processing unit and performs grid refinement processing recursively according to the preset refinement levels.

As an example, as shown in FIG. 3, the processes shown in (a), (b), (c), (d), and (e) of FIG. 3 show flows of the recursive adaptive refinement algorithm. In (a) of FIG. 3, the dark-colored points refer to control points or fault points. According to the adaptive refinement strategy, the grid where the control point or fault point is located should be refined and densified, with 3×3 region centered on the grid where it is located currently as a basic processing unit of the recursive adaptive refinement algorithm.

As shown in (b) of FIG. 3, the refinement algorithm marks grids based on refinement levels. More particularly, grids where control points or fault points are located are marked as level 2, grids directly adjacent to grids where control points or fault points are located are marked as level 1, and other grids are marked as level 0. The refinement algorithm may be used to perform grid refinement on grids marked as level 2 or level 1, and the results are shown in (c) of FIG. 3. The grid region where the control points or fault points are located is refined and densified, while other regions remain in a coarse grid state.

The fault points or control points may be pre-specified or automatically identified. After one refining processing is completed, the refinement algorithm may check the refinement level of the grid where the control points or fault points are located. When the refinement level is less than the specified refinement level, the algorithm continues the recursive refining processing, as shown in (c) and (d) of FIG. 3, with 3*3 region previously refined and centered on the grid where the control points or fault points are located as the processing unit for the next round of marking and refining.

As shown in (e) of FIG. 3, when the refinement algorithm detects that the refinement level of the grid where the control points or fault points are located is one less than the specified refinement level, the recursive process is terminated. At the same time, grids currently marked as level 2 are refined once more, so that the current grid reaches the specified refinement level. The refinement level of the adjacent grids surrounding the current grid differs by 1, ensuring the consistency of the differentiation format.

In some embodiments, the storing grid data of the second grid set includes: storing grids of each level separately according to respective refinement levels; wherein each layer of grids in single-layer grid structure of each level in the first storage space are regarded as uniform grids corresponding to a resolution of respective refinement level; marks of grid points in the single-layer grid is stored in a second storage space, where index values of grid points that actually exist in the second grid set are stored, and grid points that do not exist are marked as −1.

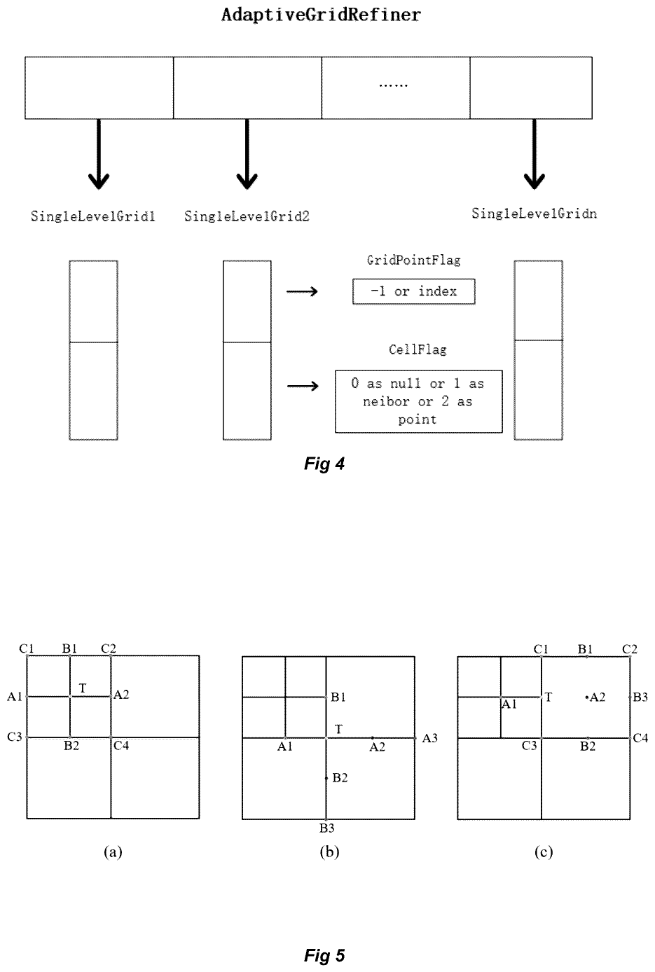

The layered data structure for adaptive grids is shown in FIG. 4, and may store grid information in regions of varying density effectively and enables fast and efficient data access. The AdaptiveGridRefiner class serves as the container for the entire adaptive grid system. Grids of each refinement level are stored separately based on the refinement levels. SingleLevelGrid (which may be understood as the first storage space) stores single-layer grids as uniform grids corresponding to the resolution of the refinement levels. GridPointFlag (which may be understood as the second storage space) stores the marks of grid points in the single-layer grid, and index values of grid points that actually exist in the second grid set are stored, and grid points that do not exist are marked as −1. CellFlag (which may be understood as the second storage space) is used to store the grid marks shown in (b) of FIG. 3.

Therefore, in such data structure, tree structures are no longer used to store grid elements. Instead, grids of different refinement levels are stored separately, so that the large memory overhead caused by pointers and tree nodes in tree structures may be avoided. Additionally, the new data structure does not physically construct grids but uses logical grids instead to store only the grid points within the grids. When grid structures are needed, the corresponding grid points are retrieved to generate the grids. In the single-layer grid structure, each layer of grids is stored as a uniform grid system corresponding to the resolution of the refinement level. Although this approach introduces additional memory overhead, it simplifies the storage of the entire grid. All grid points are stored in a sequential structure, so that the time overhead for retrieving grid point is reduced significantly, which is beneficial for subsequent discretization methods such as finite difference.

In some embodiments, the performing differentiation on the second grids in the second grid set includes: determining whether to add points to the second grids; performing interpolating based on existing grid points to obtain missed grid points in response to a determination for adding points to the second grids, and performing differentiation with the added points.

In some embodiments, the determining whether to add points to the second grids includes: determining whether grid points of the same level in neighborhood of point T to be differentiated are missing for the point T to be differentiated; making determination for adding the missing grid points, if grid points of the same level in neighborhood of point T to be differentiated are missing.

In some embodiments, the performing interpolating based on existing grid points to obtain missed grid points in response to a determination for adding points to the second grids includes: adding points for the missing grid point based on two endpoints of the grid line, if the missing grid point is located on the grid line; adding points for the missing grid point based on points on the grid lines of the grid where a grid center is located, if the missing grid point is located at the grid center.

In some embodiments, the performing interpolating based on existing grid points to obtain missed grid points in response to a determination for adding points to the second grids includes: adding points for the missing points on the grid lines of a three-dimensional grids based on existing points on the grid lines to obtain points on lines of the three-dimensional grids, if the missing grid point is located at a centroid of a three-dimensional grids; and adding points for the missing points located at the centroid of the three-dimensional grids based on the points on lines of the three-dimensional grids

As an example, as shown in FIG. 5, (a), (b), and (c) of FIG. 5 illustrate three differentiation methods in a two-dimensional adaptive grid system. In the two-dimensional adaptive grid system, differentiation can be performed by adding points on grid lines or at grid centers based on the neighborhood situations.
(a) of FIG. 5 illustrates an adaptive differentiation scenario without adding points. At this time, point T is located at the center of a refined grid, and there are all grids surrounding it and having the same refinement level as the refined grid. No point is required to be added for differentiation. Taking differentiation in the x-direction as an example, the differentiation formula is as follows, consistent with the finite difference of uniform grids:

$$\frac{{\partial }^{2} u}{\partial {x}^{2}} {\vert}_{i , j , k} \approx \frac{{u}_{i + 1 , j , k} - 2 {u}_{i , j , k} + {u}_{i - 1 , j , k}}{Δ {x}^{2}}$$

(b) of FIG. 5 illustrates a differentiation scenario with point added on grid lines. To perform finite difference on point T, it is observed that points A2 and B2, which are at the same refinement level as points A1 and B1 in neighborhood of point T, are missing and points are needed to be added. Point A2 is obtained by interpolating based on known points T and A3, and point B2 is obtained by interpolating based on known points T and B3, as shown in the following formulas:

$${u}_{A 2} = \frac{1}{2} {u}_{T} + \frac{1}{2} {u}_{A 3}$$

$${u}_{B 2} = \frac{1}{2} {u}_{T} + \frac{1}{2} {u}_{B 3}$$

After points A2 and B2 are obtained by the processing of point adding, all relevant points in the neighborhood of T required for differentiation exist. According to the differentiation formulas:

$$\frac{{\partial }^{2} {u}_{T}}{\partial {x}^{2}} \approx \frac{{u}_{A 1} - \frac{3}{2} {u}_{T} + \frac{1}{2} {u}_{A 3}}{Δ {x}^{2}}$$

$$\frac{{\partial }^{2} {u}_{T}}{\partial {y}^{2}} \approx \frac{{u}_{B 1} - \frac{3}{2} {u}_{T} + \frac{1}{2} {u}_{B 3}}{Δ {y}^{2}}$$

(c) of FIG. 5 illustrates another differentiation scenario with point added at the grid center. To perform finite difference on point T, its neighborhood is checked, and it is found that point A2, which is at the same refinement level as point A1 in the x-direction, is missing and points are needed to be added by interpolating. Point A2 is located at the grid center and obtained by interpolating based on its neighborhood points T, B1, B2, and B3, as shown in the following formula:

$${u}_{A 2} = \frac{1}{4} {u}_{T} + \frac{1}{4} {u}_{B 1} + \frac{1}{4} {u}_{B 2} + \frac{1}{4} {u}_{B 3}$$

However, it is found that points B1, B2, and B3 are also missing by checking the neighborhood of point A2 and points are needed to be added by interpolating, as shown in the point-adding on line scenario in (b) of FIG. 5. With known points C1, C2, C3, and C4, points B1, B2, and B3 may be obtained by interpolating:

$${u}_{B 1} = \frac{1}{2} {u}_{C 1} + \frac{1}{2} {u}_{C 2}$$

$${u}_{B 2} = \frac{1}{2} {u}_{C 3} + \frac{1}{2} {u}_{C 4}$$

$${u}_{B 3} = \frac{1}{2} {u}_{C 2} + \frac{1}{2} {u}_{C 4}$$

By substituting the above equations into the differentiation template, the differentiation formula for point T in the x-direction is obtained:

$$\frac{{\partial }^{2} {u}_{T}}{\partial {x}^{2}} \approx \frac{{u}_{A 1} - \frac{7}{4} {u}_{T} + \frac{1}{8} {u}_{C 1} + \frac{1}{4} {u}_{C 2} + \frac{1}{8} {u}_{C 3} + \frac{1}{4} {u}_{C 4}}{Δ {x}^{2}}$$

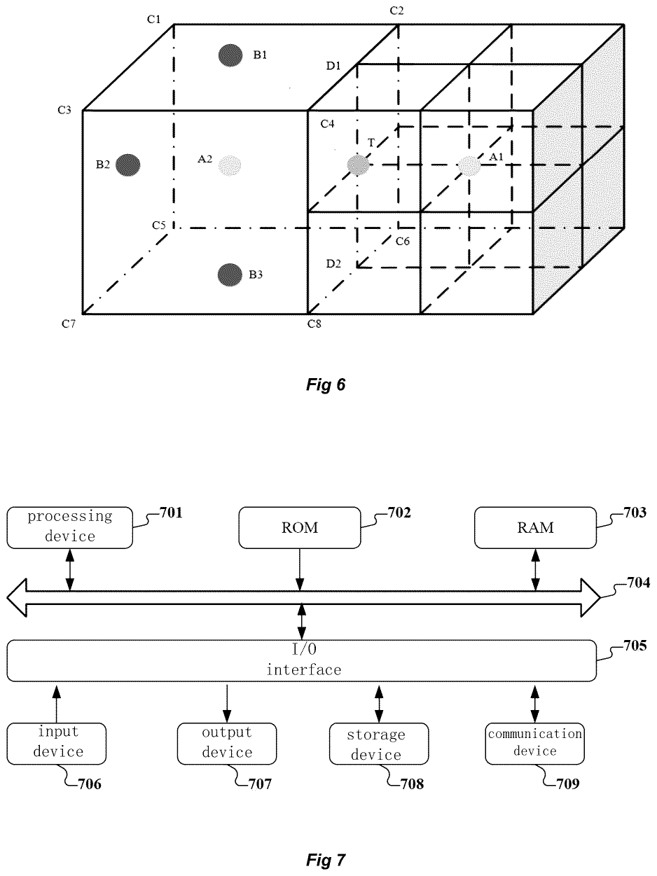

As an example, as shown in FIG. 6, which shows the method for adding points at centroid for regular hexahedrons in three-dimensional adaptive grids. As shown in FIG. 6, during the differentiation process for point T, it is found that point A2, which is at the same refinement level as point A1, is missing. Point A2 is located at the centroid of the regular hexahedron grid, and thus there is a new differentiation scenario for adding points, namely points adding at centroid for regular hexahedrons. At this time, point A2 should be obtained by interpolating based on points T, B1, B2, and B3. However, points B1, B2, and B3 are also missing. It is observed that points B1, B2, and B3 may be obtained by adding points at centroid based on known points C1 to C8 and D1, D2. With the method of adding points at centroid, point A2 can be obtained as follows:

$${u}_{A 2} = \frac{1}{4} {u}_{T} + \frac{1}{8} {u}_{C 1} + \frac{1}{32} {u}_{C 2} + \frac{1}{8} {u}_{C 3} + \frac{1}{32} {u}_{C 4} + \frac{1}{8} {u}_{C 5} + \frac{1}{32} {u}_{C 6} + \frac{1}{8} {u}_{C 7} + \frac{1}{32} {u}_{C 8} + \frac{1}{4} {u}_{D 1} + \frac{1}{4} {u}_{D 2}$$

After obtaining u_{A2}, point T can be differentiated according to the finite difference method for uniform grids. With the method of adding points at centroid and differentiation, finite difference methods for any differentiation scenario in three-dimensional adaptive grids may be implemented by combining method of normal uniform grid differentiation, method of adding points on grid line and differentiation, method of adding points on grid center and differentiation, and method of adding points at hexahedron centroid and differentiation.

In one or more embodiments of the present disclosure, after completing the differentiation of all grid points in the adaptive grid system, the differentiation coefficients are organized into a coefficient matrix. Combined with point constraints and directional constraint conditions, a linear equation set in the form of Ax=b is formed by using the Lagrange multiplier method. The values of all grid points in the adaptive grid system may be obtained by solving the linear system.

Referring to FIG. 7, which shows a schematic diagram of an electronic apparatus configured to implement the embodiments of the present disclosure. The terminal device in the embodiments of the present disclosure may include, but is not limited to, mobile terminals such as mobile phones, laptops, digital broadcast receivers, PDAs (personal digital assistants), PADs (tablet computers), PMPs (portable multimedia players), in-vehicle terminals (e.g., in-vehicle navigation terminals), and fixed terminals such as digital TVs and desktop computers. The electronic apparatus shown in FIG. 7 is merely an example and should not impose any limitations on the functions and scope of use of the embodiments of the present disclosure.

As shown in FIG. 7, the electronic apparatus may include a processing device (e.g., a central processing unit, graphics processing unit, etc.) 701, which may perform various appropriate operations and processes based on programs stored in a read-only memory (ROM) 702 or programs loaded into a random-access memory (RAM) 703 from a storage device 708. Various programs and data required for the operation of the 700 are also stored in the RAM 703. The processing unit 701, ROM 702, and RAM 703 are interconnected via a bus 704. An input/output (I/O) interface 705 is also connected to the bus 704.

Typically, the following devices may be connected to the I/O interface 705: input devices 706 including, for example, a touch screen, touchpad, keyboard, mouse, camera, microphone, accelerometer, gyroscope, etc.; output devices 707 including, for example, a liquid crystal display (LCD), speaker, vibrator, etc.; storage devices 708 including, for example, magnetic tapes, hard disks, etc.; and communication devices 709. The communication device 709 may enable the electronic apparatus to communicate with other devices wirelessly or through wired connections to exchange data. Although FIG. 7 illustrates an electronic apparatus with various devices, it should be understood that it is not required to implement or include all the devices shown. More or fewer devices may alternatively be implemented or included.

Specifically, according to the embodiments of the present disclosure, the processes described above with reference to the flowcharts may be implemented as computer software programs. For example, the embodiments of the present disclosure include a computer program product including a computer program carried on a non-transitory computer-readable medium, the computer program containing program code for executing the method shown in the flowcharts. In such embodiments, the computer program may be downloaded and installed from a network via the communication device 709, installed from the storage device 708, or installed from the ROM 702. When the computer program is executed by the processing unit 701, the functions defined in the methods of the embodiments of the present disclosure are performed.

It should be noted that the computer-readable medium described in the present disclosure may be a computer-readable signal medium or a computer-readable storage medium or any combination of the two. A computer-readable storage medium may include, but is not limited to, an electrical, magnetic, optical, electromagnetic, infrared, or semiconductor system, apparatus, or device, or any combination of the foregoing. More specific examples of computer-readable storage media may include, but are not limited to, electrical connections with one or more wires, portable computer disks, hard disks, random access memory (RAM), read-only memory (ROM), erasable programmable read-only memory (EPROM or flash memory), optical fiber, portable compact disc read-only memory (CD-ROM), optical storage devices, magnetic storage devices, or any suitable combination of the foregoing. In the present disclosure, a computer-readable storage medium may be any tangible medium that contains or stores programs that can be used by or in conjunction with an instruction execution system, apparatus, or device. In the present disclosure, a computer-readable signal medium may include a propagated data signal in baseband or as part of a carrier wave, where the propagated data signal carries computer-readable program code. Such propagated data signals may take various forms, including but not limited to electromagnetic signals, optical signals, or any suitable combination of the foregoing. A computer-readable signal medium may also include any computer-readable medium other than a computer-readable storage medium that transmits, propagates, or transfers programs for use by or in conjunction with an instruction execution system, apparatus, or device. The program code contained on the computer-readable medium may be transmitted using any appropriate medium, including but not limited to electrical wiring, optical cables, RF (radio frequency), etc., or any suitable combination of the foregoing.

In some embodiments, the client and server may communicate by using any currently known or future-developed network protocols, such as HTTP (HyperText Transfer Protocol), and may be interconnected via any form or medium of digital data communication (e.g., communication networks). Examples of communication networks include local area networks (LAN), wide area networks (WAN), internetworks (e.g., the Internet), and peer-to-peer networks (e.g., ad hoc peer-to-peer networks), as well as any currently known or future-developed networks.

The above-described computer-readable medium may be included in the electronic apparatus or may exist separately without being integrated into the electronic apparatus.

The above-described computer-readable medium carries one or more programs that, when executed by the electronic apparatus, cause the electronic apparatus to: perform initial grid division on a computational region according to geological modeling parameters and geological source data to obtain a first grid set; determine grids to be refined in the first grid set according to a preset determination rule; divide the grids to be refined into sub-element sets according to a preset refinement rule to obtain a second grid set of the computational region; store grid data of the second grid set; perform differentiation on the second grids in the second grid set and determine a coefficient matrix A based on differentiation coefficients; construct a linear equation set Ax=b based on the Lagrange multiplier method, where vector b is used to represent point constraints and directional constraint conditions; solve the linear equation set to obtain second grid values, and output modeling results based on the second grid values.

The computer program code for performing the operations of the present disclosure may be written in one or more programming languages or a combination thereof, including but not limited to object-oriented programming languages such as Java, Smalltalk, C++, and procedural programming languages such as C or similar programming languages. The program code may execute entirely on the user's computer, partly on the user's computer, as a standalone software package, partly on the user's computer and partly on a remote computer, or entirely on a remote computer or server. In the case of remote computers, the remote computer may be connected to the user's computer through any type of network, including a local area network (LAN) or a wide area network (WAN), or may be connected to an external computer (e.g., through an Internet service provider to connect via the Internet).

The flowcharts and block diagrams in the drawings illustrate possible system architectures, functionalities, and operations of the systems, methods, and computer program products according to various embodiments of the present disclosure. In this regard, each block in the flowcharts or block diagrams may represent a module, program segment, or portion of code that contains one or more executable instructions for implementing specified logical functions. It should also be noted that, in some alternative implementations, the functions noted in the blocks may occur out of the order noted in the drawings. For example, two blocks shown in succession may, in fact, be executed substantially concurrently, or the blocks may sometimes be executed in the reverse order, depending on the functionality involved. It should also be noted that each block in the block diagrams and/or flowcharts, as well as combinations of blocks in the block diagrams and/or flowcharts, can be implemented by a special-purpose hardware-based system that performs the specified functions or operations, or by a combination of special-purpose hardware and computer instructions.

The units involved in the embodiments of the present disclosure may be implemented in software, hardware, or a combination thereof. The names of the units do not limit the units themselves in certain cases.

The functions described herein may be performed, at least in part, by one or more hardware logic components. For example, and without limitation, exemplary types of hardware logic components that may be used include field-programmable gate arrays (FPGAs), application-specific integrated circuits (ASICs), application-specific standard products (ASSPs), system-on-chips (SoCs), complex programmable logic devices (CPLDs), and the like.

In the context of the present disclosure, a machine-readable medium may be a tangible medium that can contain or store programs for use by or in conjunction with an instruction execution system, apparatus, or device. The machine-readable medium may be a machine-readable signal medium or a machine-readable storage medium. A machine-readable medium may include, but is not limited to, electronic, magnetic, optical, electromagnetic, infrared, or semiconductor systems, devices, or apparatuses, or any suitable combination of the foregoing. More specific examples of machine-readable storage media may include electrical connections based on one or more wires, portable computer disks, hard disks, random access memory (RAM), read-only memory (ROM), erasable programmable read-only memory (EPROM or flash memory), optical fibers, portable compact disc read-only memory (CD-ROM), optical storage devices, magnetic storage devices, or any suitable combination of the foregoing.

The above descriptions are merely preferred embodiments of the present disclosure and explanations of the technical principles employed. Those skilled in the art should understand that the scope of the present disclosure is not limited to the specific combinations of technical features disclosed above but also encompasses other technical solutions formed by any combination of the above technical features or their equivalents without departing from the disclosed concepts. For example, the above features may be replaced with other technical features disclosed in the present disclosure (but not limited to) that have similar functions to form other technical solutions.

Furthermore, although specific orders of operations are depicted, this should not be understood as requiring these operations to be performed in the specific order shown or in sequential order. In certain environments, multitasking and parallel processing may be advantageous. Similarly, while various specific implementation details are included in the above discussion, these should not be construed as limitations on the scope of the present disclosure. Certain features described in the context of separate embodiments may also be implemented in combination in a single embodiment. Conversely, various features described in the context of a single embodiment may also be implemented separately or in any suitable sub-combination in multiple embodiments.

Although the subject matter has been described in language specific to structural features and/or methodological acts, it is to be understood that the subject matter defined in the appended claims is not necessarily limited to the specific features or acts described above. Rather, the specific features and acts are disclosed as example forms of implementing the claims.

1. A method for implicit geological modeling based on adaptive grids, comprising:
performing initial grid division on a computational region according to geological modeling parameters and geological source data to obtain a first grid set;
determining grids to be refined in the first grid set according to a preset determination rule;
dividing the grids to be refined into sub-element sets according to a preset refinement rule to obtain a second grid set of the computational region;
storing grid data of the second grid set;
performing differentiation on the second grids in the second grid set and determining a coefficient matrix A based on differentiation coefficients;
constructing a linear equation set Ax=b based on the Lagrange multiplier method, where vector b is used to represent point constraints and directional constraint conditions;
solving the linear equation set to obtain second grid values, and outputting modeling results based on the second grid values.

2. The method according to claim 1, wherein the determining grids to be refined in the first grid set according to a preset determination rule comprises:
marking grids based on refinement levels, where grids containing control points or fault points are marked as level 2, grids directly adjacent to grids containing control points or fault points are marked as level 1, and other grids are marked as level 0;
determining grids marked as level 2 or 1 as the grids to be refined.

3. The method according to claim 2, wherein the dividing the grids to be refined into sub-element sets according to a preset refinement rule to obtain a second grid set of the computational region comprises:
performing refinement on the grid region where the grid to be refined is located with a 3*3 grid region centered on the grid to be refined as the basic processing unit;
checking a refinement level of the grid where the grid to be refined is located after one refinement process is completed;
continuing refinement recursively, if the refinement level of the grid where the grid to be refined is located is less than a specified refinement level;
stopping a recursive process, if the refinement level of the grid to be refined is less than the specified refinement level by one, and performing one more refinement on grids currently marked as level 2, so that the grid to be refined reaches the specified refinement level, and the refinement level difference between grids adjacent to the grid to be refined and the grid to be refined is 1.

4. The method according to claim 3, wherein the performing refinement on the grid region where the grid to be refined is located comprises:
adding four edge nodes and one center node to the grid in the grid region, and forming four refined grid elements with the nodes newly added and original grid nodes.

5. The method according to claim 2, wherein the storing grid data of the second grid set comprises:
storing grids of each level separately according to respective refinement levels;
wherein each layer of grids in single-layer grid structure of each level in the first storage space are regarded as uniform grids corresponding to a resolution of respective refinement level;
marks of grid points in the single-layer grid are stored in a second storage space, where index values of grid points that actually exist in the second grid set are stored, and grid points that do not exist are marked as −1.

6. The method according to claim 5, wherein the performing differentiation on the second grids in the second grid set comprises:
determining whether to add points to the second grids;
performing interpolating based on existing grid points to obtain missed grid points in response to a determination for adding points to the second grids, and performing differentiation with the added points.

7. The method according to claim 6, wherein the determining whether to add points to the second grids comprises:
determining whether grid points of the same level in neighborhood of point T to be differentiated are missing for the point T to be differentiated;
making determination for adding points for the missing grid points, if grid points of the same level in neighborhood of point T to be differentiated are missing.

8. The method according to claim 7, wherein the performing interpolating based on existing grid points to obtain missed grid points in response to a determination for adding points to the second grids comprises:
adding points for the missing grid point based on two endpoints of the grid line, if the missing grid point is located on the grid line;
adding points for the missing grid point based on points on the grid lines of the grid where a grid center is located, if the missing grid point is located at the grid center.

9. The method according to claim 7, wherein the performing interpolating based on existing grid points to obtain missed grid points in response to a determination for adding points to the second grids comprises:
adding points for the missing points on the grid lines of a three-dimensional grids based on existing points on the grid lines to obtain points on lines of the three-dimensional grids, if the missing grid point is located at a centroid of a three-dimensional grids;
adding points for the missing points located at the centroid of the three-dimensional grids based on the points on lines of the three-dimensional grids.

10. An electronic apparatus, comprising:
one or more processors;
a storage device configured to store one or more programs,
wherein the one or more programs, when executed by the one or more processors, cause the one or more processors to implement the method according to claim 1.
